(19) United States
(12) Patent Application Publication
(10) Pub. No.: US 2013/0211068 A1
(43) Pub. Date: Aug. 15, 2013

(54) BINDER, COMPOSITION FOR USE IN MAKING THE BINDER, AND METHODS OF MAKING THE SAME

(71) Applicants: Kevin R. Anderson, Cedar Rapids, IA (US); Larry Todd Banner, Ottumwa, IA (US); Shuang Zhou, Pella, IA (US)

(72) Inventors: Kevin R. Anderson, Cedar Rapids, IA (US); Larry Todd Banner, Ottumwa, IA (US); Shuang Zhou, Pella, IA (US)

(21) Appl. No.: 13/878,127

(22) PCT Filed: Oct. 8, 2010
(86) PCT No.: PCT/US10/52083

§ 371 Date: Apr. 5, 2013

(51) Int. Cl. C08B 31/04

(52) U.S. Cl. CPC C08B 31/04
USPC 536/103

(57) ABSTRACT

According to one embodiment, there is provided a composition for use in making a cured binder, the composition comprising: a first mixture comprising citric acid and an alkali metal hydroxide or an aqueous solution comprising the reaction products thereof; wherein the molar ratio of the alkali metal hydroxide to citric acid is between about 0.001:1 to 0.6:1, and wherein the pH of the first mixture is about 0.5 to about 2.5 when the first mixture is a 50% by weight citric acid aqueous solution.

### DESCRIPTION OF RELATED ART

There is a need in the art for formaldehyde-free or reduced formaldehyde binders for use in various products for example, bonded fiberglass products. Various attempts have been made to reduce or eliminate undesirable formaldehyde in resins or binders and maintain the desirable properties of the resins or binders. This reduction or elimination of formaldehyde can reduce or eliminate emission of formaldehyde emissions from products containing the resins. The removal of formaldehyde also means that there are no binder-related emissions of formaldehyde during manufacturing processes, either to the outdoor environment or to the indoor working areas.

Some previous arts have focused on the use of polyacrylic acid with a polyhydroxy crosslinking agent or carbohydrate-based chemistry that is linked to the Maillard reaction. Polyacrylic acid inherently has problems due to its acidity and associated corrosion of machine parts. In addition, polyacrylic acid binders have a high viscosity, high curing temperatures, and high associated curing costs. Also, the use of large amounts of ammonia needed to make the binder presents a safety risk and possible emission problems.

Accordingly, there is a need in the art for an improved binder and compositions for use in making the binder, and methods of making the same.

### SUMMARY

According to one embodiment, there is provided a composition for use in making a cured binder, the composition comprising: a first mixture comprising citric acid and an alkali metal hydroxide, or an aqueous solution comprising the reaction products thereof; wherein the molar ratio of the alkali metal hydroxide to citric acid is between about 0.001:1 to 0.6:1, and wherein the pH of the first mixture is about 0.5 to about 2.5 when in a 50% by weight citric acid aqueous solution.

In another embodiment, there is provided a method for making a composition for use in making a cured binder, the method comprising: mixing citric acid and an alkali metal hydroxide to form an aqueous solution comprising the reaction products thereof; wherein the molar ratio of the alkali metal hydroxide to citric acid before mixing is between about 0.001:1 to about 0.6:1, and wherein the pH of the aqueous solution is about 0.5 to 2.5 when in a 50% by weight citric acid aqueous solution.

In another embodiment, there is provided a composition for use in making a cured binder, the composition comprising: a first mixture comprising citric acid and alkali metal salt of citric acid, or an aqueous solution comprising the reaction products thereof, wherein the molar ratio of the alkali metal salt of citric acid to citric acid is between about 0.0003:1 to about 0.2:1, and wherein the pH of the first mixture is about 0.5 to 2.5 when in a 50% by weight citric acid aqueous solution.

In another embodiment, there is provided a method for making a composition for use in making a cured binder, the method comprising: mixing citric acid and alkali metal salt of citric acid to form an aqueous solution comprising the reaction products thereof, wherein the molar ratio of the alkali metal salt of citric acid to citric acid is between about 0.0003:1 to about 0.2:1 before mixing, and wherein the pH of the aqueous solution is about 0.5 to 2.5 when the aqueous solution is a 50% by weight citric acid aqueous solution.

In another embodiment, there is provided a composition for use in making a cured binder, the composition comprising: an aqueous solution comprising the reaction products of citric acid and (i) an alkali metal salt of citric acid, (ii) an alkali metal hydroxide, or (iii) mixtures thereof; wherein about 0.03% to 20% of the carboxylic acid groups of the citric acid are neutralized in the aqueous solution, and the pH of the aqueous solution is about 0.5 to 2.5 when the aqueous solution is an about 50% by weight citric acid aqueous solution.

In another embodiment, there is provided a composition for use in making a cured binder, the composition comprising: an aqueous solution comprising a carbohydrate, and the reaction products of citric acid, and (i) an alkali metal salt of citric acid, (ii) an alkali metal hydroxide, or (iii) mixtures thereof, wherein about 0.03% to 20% of the carboxylic acid groups of the citric acid are neutralized in the aqueous solution prior to curing, the ratio of carbohydrate to citric acid is about 1:1 to 9:1 by weight, and upon curing to form a cured binder, the amount of citric acid in the cured binder is about 20% or less of the amount of citric acid in the aqueous solution prior to curing.

In another embodiment, there is provided a method of making a cured binder, the method comprising: providing a first aqueous solution comprising the reaction products of citric acid and (i) an alkali metal salt of citric acid, (ii) an alkali metal hydroxide, or (iii) mixtures thereof, wherein about 0.03% to 20% of the carboxylic acid groups of the citric acid are neutralized in the first aqueous solution, combining the first aqueous solution with a carbohydrate to form a second aqueous solution, wherein the ratio of carbohydrate to citric acid in the second aqueous solution is about 1:1 to 9:1 by weight; curing the second aqueous solution at an elevated temperature for a sufficient time to form a cured binder, wherein the amount of citric acid in the cured binder is about 20% or less of the amount of citric acid in the second aqueous solution.

In another embodiment, there is provided a method of making a cured binder, the method comprising: combining citric acid, (i) an alkali metal acid salt of citric acid, (ii) a alkali metal hydroxide, or (iii) a mixture thereof, a carbohydrate, and water to form a first aqueous solution, wherein about 0.03% to 20% of the carboxylic acid groups of the citric acid are neutralized in the first aqueous solution, and the ratio of carbohydrate to citric acid is about 1:1 to 9:1 by weight; curing the first aqueous solution at an elevated temperature for a sufficient time to form a cured binder, wherein the amount of citric acid in the cured binder is about 20% or less of the amount of citric acid combined to form the first aqueous solution.

In another embodiment, there is provided a method of promoting esterification of citric acid with a carbohydrate, the method comprising: combining citric acid, (i) an alkali metal acid salt of citric acid, (ii) a alkali metal hydroxide, or (iii) a mixture thereof, a carbohydrate, and water to form a first aqueous solution, wherein about 0.03% to 20% of the carboxylic acid groups of the citric acid are neutralized in the first aqueous solution, and the ratio of carbohydrate to citric acid combined in the first aqueous solution is about 1:1 to 9:1 by weight; heating the first aqueous solution at an elevated temperature for a sufficient time to esterify at least 80% of the citric acid combined in the first aqueous solution.

### BRIEF DESCRIPTION OF THE DRAWINGS

FIG. 1 shows a strength test comparison of various binders according to some embodiments of the invention.

FIG. 2 shows absorbance FT-IR spectra of fiberglass samples prepared with various binders according to some embodiments of the invention.

FIGS. 3 and 4 show cure profiles for binders according to embodiments herein.

FIG. 5 shows a strength comparison for binders made from compositions including sodium and potassium.

### DETAILED DESCRIPTION

The following description is intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein.

In one embodiment, a cured binder is provided, wherein the cured binder is made from a mixture comprising a (1) carbohydrate, (2) citric acid, and (3) an alkali metal hydroxide or an alkali metal salt of citric acid, or a mixture thereof, wherein the components of said mixture can be in an aqueous solution. The binder is cured at an elevated temperature for a time sufficient to cure the binder without burning.

In this embodiment, the carbohydrate can be natural in origin and derived from renewable resources. For example, the carbohydrate may be derived from plant sources such as legumes, maize, corn, waxy corn, sugar cane, milo, white milo, potatoes, sweet potatoes, tapioca, rice, waxy rice, peas, sago, wheat, oat, barley, rye, amaranth, and/or cassava, as well as other plants that have a high starch content. The carbohydrate can be a polymer derived from crude starch-containing products derived from plants that contain residues of proteins, polypeptides, lipids, and low molecular weight carbohydrates. The carbohydrate may be selected from monosaccharides (e.g., xylose, glucose, and fructose), disaccharides (e.g., sucrose, maltose, and lactose), oligosaccharides (e.g., glucose syrup and fructose syrup), and polysaccharides and water-soluble polysaccharides (e.g., pectin, dextrin, maltodextrin, starch, modified starch, and starch derivatives).

The carbohydrate may have a number average molecular weight from about 150 to about 8000, or 1,000 to about 8,000. Additionally, the carbohydrate may have a dextrose equivalent (DE) number from 2 to 20, from 15 to 20, from 18 to 20, from 10 to 15, from 11 to 14, or from 7 to 11. In one or more exemplary embodiment, the DE number may be from 11 to 13, from 8 to 13, or from 9 to 11. In other exemplary embodiments, the DE number may be from 16 to 19 or from 16 to 18. In some embodiments, the DE number may be as high as 99, and in other embodiments, up to 75, up to 50, up to 30, or up to 30. It is to be appreciated that any water soluble carbohydrate, corn syrup, dextrose, or maltodextrose may be used alone or in combination in the inventive binder composition. The carbohydrates beneficially have a low viscosity and cure at moderate temperatures (e.g., 80-250° C.) by itself or with additives. It is to be understood that applied oven temperature can be higher, e.g., 100-325° C. to effectuate curing at the desired temperature. The low viscosity enables the carbohydrate to be utilized in a binder composition. In exemplary embodiments, the viscosity of the carbohydrate may be lower than 500 cps at 50% concentration. The use of a carbohydrate in the binder composition is advantageous in that carbohydrates are readily available or easily obtainable and are low in cost.

Further, in this embodiment, the carbohydrate can be a water-soluble polysaccharide such as dextrin or maltodextrin. The carbohydrate may be present in the binder composition in an amount from about 50% to about 90%, or in other aspects, could be as high as 95%, by weight of the total solids in the binder composition, from about 60% to about 75%, from about 65% to about 85%, from about 70% to about 90% by weight, or from about 80% to about 90% by weight. In at least one exemplary embodiment, the carbohydrate may be present in the binder composition in an amount from about 70% to about 80% by weight, from about 65% to about 70% by weight, from about 75% to about 85% by weight, from about 75% to about 80% by weight, or from about 80% to about 85% by weight.

In this embodiment, the mixture further comprises citric acid. The citric acid may be present in the mixture in an amount up to about 10%-50% by weight of the binder composition. In exemplary embodiments, citric acid may be present in the mixture in an amount from about 5% to about 30% by weight of the total solids mixture, from about 10% to about 30% by weight, from about 10% to about 20% by weight, or from about 15% to about 20% by weight. In some exemplary embodiments, citric acid may be present in the mixture in an amount from about 20% to about 35% by weight, from about 25% to about 35% by weight, from about 25% to about 30% by weight, from about 30% to about 35% by weight, or from about 27% to about 33% by weight. In yet other embodiments, citric acid may be present in the mixture in an amount from about 15% to about 25% by weight, from about 15% to about 20% by weight, from about 20% to about 25% by weight, or from about 18% to about 22% by weight.

In this embodiment, the mixture also includes an alkali metal hydroxide or an alkali metal salt of citric acid, or a mixture thereof. In one aspect, the alkali metal hydroxide can include lithium, sodium, potassium, rubidium, or cesium hydroxide. In another aspect, the alkali metal salt of citric acid can include mono-, di-, or tri-lithium, sodium, potassium, rubidium or cesium citrate including hydrates thereof (for example, trisodium citrate mono- or di-hydrate (TSC)). Preferably, the alkali metal is sodium or potassium.

As used herein, the term “alkali metal” refers to a metal in group IA of the periodic table, i.e., lithium, sodium, potassium, rubidium, cesium, and francium, and the term “alkaline-earth metal” refers to a metal in group IIA of the periodic table, i.e., beryllium, magnesium, calcium, strontium, barium, and radium.

It is to be understood that, unless otherwise indicated, reference to a compound also refers to aqueous solution of the compound with the understanding that compound or a combination of compounds may disassociate or form a reaction product in the aqueous solution. For example, reference to sodium hydroxide may refer to non-aqueous sodium hydroxide or an aqueous solution of sodium hydroxide in which the sodium hydroxide may have disassociated in the aqueous solution. Moreover, the term “reaction product” includes the product that results from the neutralization reaction between the alkali metal hydroxide and the citric acid and/or the product that results from the equilibrium that is obtained when an alkali metal citrate salt and citric acid are added together in an aqueous mixture. Reference to the wt. percentage of a compound generally refers to the dry weight percentage unless indicated otherwise. And, as set forth herein, pH is measured at 25° C. and 760 Torr.

Unexpectedly, it has been found that the use of a particular ratio of alkali metal hydroxide to citric acid or a particular ratio of an alkali metal salt of citric acid to citric acid in the mixtures of this embodiment provides a synergistic effect such that sufficient curing of the binder occurs upon curing of the mixture that is comparable to binder compositions, in which an auxiliary compound as set forth herein is used alone in place of the reaction products of alkali metal hydroxide or alkali metal salt of citric acid with citric or mixtures thereof.

Alternatively, a suitable amount of alkali metal hydroxide or alkali metal salt of citric acid, or any combination thereof, for use in some embodiments can be determined by providing an amount of alkali metal hydroxide or alkali metal salt of citric acid, or any combination thereof, such that about 0.03% to 20%, about 1.5% to 10%, or 3% to 7% of the carboxylic acid groups of the citric acid are neutralized when in solution with the citric acid. Accordingly, one can calculate a suitable amount of alkali metal hydroxide or alkali metal salt of citric acid, or any combination thereof, based upon the amount of carboxylic acid groups of the citric acid that are to be neutralized.

Without being limited by theory, for some embodiments herein it is believed that the use of a reaction product of citric acid with an alkali metal hydroxide, alkali metal salt of citric acid or mixture thereof, and the particular ratios and reaction conditions set forth herein promote sufficient reaction between the carbohydrate and citric acid, including anions or anhydrides of citric acid, to form higher molecular weight compounds. This reaction can be considered to include crosslinking, esterification and/or coupling of the citric acid with the carbohydrate during the curing process, where coupling includes bonds formed during esterification. As such, the reaction product of citric acid with an alkali metal hydroxide, an alkali metal salt of citric acid, or mixtures thereof, may be referred to as crosslinking promoters in some embodiments set forth herein.

In some embodiments, a suitable amount of alkali metal hydroxide or alkali metal salt of citric acid, or any combination thereof to be added to citric acid is defined as an amount sufficient such that upon curing, the amount of citric acid in the cured binder is about 20%, 15%, 10% 5%, or 3% or less of the amount of citric acid in the composition or mixture prior to curing. Without being limited by theory, it is believed that the reduction of citric acid during curing is due to the esterification of the citric acid with the carbohydrate during curing such that preferably 80%, 85%, 90%, 95%, or 97% or more of the citric acid in the composition or mixture prior to curing is esterified during the curing.

In another embodiment, the mixture can also include the reaction product of citric acid and an alkali metal hydroxide or alkali metal salt of citric acid, or any combination thereof, in combination with an auxiliary compound to promote esterification. Examples of suitable auxiliary compounds include inorganic salts, Lewis acids (i.e., aluminum chloride or boron trifluoride), Bronsted acids (i.e., sulfuric acid, p-toluenesulfonic acid and boric acid) organometallic complexes (i.e., lithium carboxylates, sodium carboxylates), and/or Lewis bases (i.e., polyethyleneimine, diethylamine, or triethylamine). Additionally, auxiliary compounds may include an alkali metal salt of a phosphorous-containing organic acid; in particular, alkali metal salts of phosphorus acid, hypophosphorus acid, or polyphosphoric acids. Examples of such phosphorus catalysts include, but are not limited to, sodium hypophosphite, sodium phosphate, potassium phosphate, disodium pyrophosphate, tetrasodium pyrophosphate, sodium tripolyphosphate, sodium hexamethaphosphate, potassium phosphate, potassium tripolyphosphate, sodium trimetaphosphate, sodium tetramethaphosphate, and mixtures thereof. In addition, auxiliary compounds may be a fluoroborate compound such as fluoroboric acid, sodium tetrafluoroborate, potassium tetrafluoroborate, calcium tetrafluoroborate, magnesium tetrafluoroborate, zinc tetrafluoroborate, ammonium tetrafluoroborate, and mixtures thereof. Further, auxiliary compounds may be a mixture of phosphorus and fluoroborate compounds. Other sodium salts such as, sodium sulfate, sodium nitrate, sodium carbonate may also or alternatively be used as auxiliary compounds. The auxiliary compounds may be present in the mixture in an amount from about 0% to about 10% by weight of the total solids in the binder composition, or from about 1.0% to about 5.0% by weight, or from about 3.0% to about 5.0% by weight.

In one embodiment, a cured binder is provided, wherein the cured binder is made from a mixture comprising a (1) carbohydrate, (2) citric acid, and (3) an alkali metal hydroxide, wherein the components of said mixture can be in an aqueous solution including the reaction products thereof. In one aspect of this embodiment, the ratio of alkali metal hydroxide to citric acid prior to mixing is about 0.001:1 to 0.6:1, about 0.05:1 to 0.3:1, or about 0.1:1 to 0.2:1.

In another embodiment, a cured binder is provided, wherein the cured binder is made from a mixture comprising a (1) carbohydrate, (2) citric acid, and (3) an alkali metal salt of citric acid, wherein the components of the mixture can be in an aqueous solution including the reaction products thereof. In one aspect of this embodiment, the molar ratio of alkali metal salt of citric acid to citric acid is about 0.0003:1 to 0.2:1, about 0.015:1 to 0.1:1, or about 0.03:1 to 0.07:1.

In another embodiment, a cured binder is provided, wherein the cured binder is made from a composition comprising a (1) carbohydrate, (2) citric acid, and (3) any one of an alkali metal hydroxide, an alkali metal salt of citric acid, or a mixture thereof, wherein the components of said composition can be in an aqueous solution including the reaction products thereof. In one aspect of this embodiment, a suitable amount of alkali metal hydroxide and/or alkali metal salt of citric acid for use in some embodiments can be determined by providing a total amount of alkali metal hydroxide and/or alkali metal salt of citric acid, such that about 0.03% to 20%, about 1.5% to 10%, or 3% to 7% of the carboxylic acid groups of the citric acid are neutralized when the alkali metal hydroxide and alkali metal salt of citric acid is in solution with the citric acid.

In another embodiment, a composition for use in a binder as set forth herein is provided. The composition comprises citric acid and (i) an alkali metal salt of citric acid, (ii) an alkali metal hydroxide, or (iii) mixtures thereof. The composition may be provided in an aqueous solution, including in an aqueous solution comprising from about 20% to 60% by weight, or about 50% by weight citric acid. In one aspect, the composition includes ratios of (i) an alkali metal salt of citric acid, (ii) an alkali metal hydroxide, or (iii) mixtures thereof, to citric acid as set forth herein. In said embodiments, when the mixture is about a 50% by weight citric acid aqueous solution, the pH of the mixture can be 0.5 to 2.5, 0.8 to 1.8, and 1.0 to 1.4, respectively.

In another embodiment, a method for making a composition for use in a binder as set forth herein is provided. The method comprises mixing citric acid and (i) an alkali metal salt of citric acid, (ii) an alkali metal hydroxide, or (iii) mixtures thereof, to form an aqueous solution comprising the reaction products thereof. In one aspect the molar ratios of (i) an alkali metal salt of citric acid, (ii) an alkali metal hydroxide, or (iii) mixtures thereof, to citric acid can be provided as set forth herein. In one aspect, the method can include mixing an about 20%-60%, or 50% solution of citric acid with an about 20%-60%, or 50% solution of sodium hydroxide in proportions sufficient to form a composition having molar ratios of sodium hydroxide to citric acid as set forth herein. Preferably, the sodium hydroxide solution comprises a low amount of chlorides for the reasons set forth herein.

In another embodiment, a composition for use in a binder as set forth herein is provided. The composition comprises a carbohydrate, citric acid and (i) an alkali metal salt of citric acid, (ii) an alkali metal hydroxide, or (iii) mixtures thereof. The composition may be provided in an aqueous solution. In one aspect the composition includes molar ratios of (i) an alkali metal salt of citric acid, (ii) an alkali metal hydroxide, or (iii) mixtures thereof to citric acid as set forth herein. In another aspect, the composition includes about 1:1 to about 9:1 by weight carbohydrate to citric acid. In other aspects, the ratio of carbohydrate to citric acid can be any ratio set forth herein.

In another embodiment or in any embodiment herein, a cured binder is provided wherein a composition for use in a binder according to an embodiment set forth herein is cured at an elevated temperature and a time sufficient to cure the binder without burning. It is to be understood that the cured binders and binder compositions for use in binders can include other components known in the art for improving the properties, processing or manufacture of the binder. It is further understood that the cured binders and binder compositions for use in binders can include impurities.

In another aspect, preferably the impurities do not substantially degrade the properties, processing or manufacture of the binder. For example it is desirable to minimize corrosive compounds in the binder (e.g., chlorides) that may cause corrosion in a particular binder application, for example, the level of chloride in the final binder can be less than 200, 100, 70, or 50 ppm.

Further, it is preferable to minimize alkaline earth metals in the composition for use in a binder due to the interaction of the alkaline earth metal with citric acid, which can form a precipitate in the composition prior to curing and/or prevent sufficient crosslinking/esterification of citric acid during curing such that citric acid is present in the cured binder at a level sufficient to cause detrimental corrosion in particular applications of the binder.

### EXAMPLES

### Example 1

The following examples demonstrate that an inexpensive base, such as an alkali metal salt of citric acid (e.g., trisodium citrate) or an alkali metal hydroxide (e.g. sodium hydroxide), when mixed with citric acid, can effectively promote esterification of citric acid to maltodextrin.

Two binder controls were utilized as a benchmark for esterification comparison. Binder Control 1 (BC 1) contained about (weight/weight) maltodextrin (˜40%), citric acid (˜10%), sodium hypophosphite (˜3%), and balance water (˜47%). Binder Control 2 (BC 2) was made by combining about maltodextrin (˜40%), citric acid (˜10%), sodium phosphate (˜5%), and balance of water (˜45%).

Experimental binders were prepared as follows:

Binder Sample 1 (BS 1) was made by combining approximately 50% water, 40% maltodextrin, and 10% citric acid by wt.;

Binder Sample 2 (BS 2) was made by combining approximately 50% water, 40% maltodextrin, 9.73% citric acid, 0.27% trisodium citrate dihydrate by wt.;

Binder Sample 3 (BS 3) was made by combining approximately 50% water, 40% maltodextrin, 9.46% citric acid, 0.54% trisodium citrate dihydrate by wt.;

Binder Sample 4 (BS 4) was made by combining approximately 50% water, 40% maltodextrin, 8.91% citric acid, 1.09% trisodium citrate dihydrate by wt.;

Binder Sample 5 (BS 5) was made by combining approximately 50% water, 40% maltodextrin, 7.83% citric acid, 2.17% trisodium citrate dihydrate by wt.;

Binder Sample 6 (BS 6) was made by combining approximately 50% water, 40% maltodextrin, 5.66% citric acid, 4.34% trisodium citrate dihydrate by wt.; and

Binder Sample 7 (BS 7) was made by combining approximately 50% water, 40% maltodextrin, 2.59% citric acid, 7.41% trisodium citrate dihydrate by wt.

Binder Curing:

A sample (0.1-0.3 grams) of each binder was placed on an aluminum pan. The pan, containing the binder, was placed in a muffle furnace at 210° C. for the indicated cure time (1-5 minutes) and then cooled to ambient.

Extraction of Cured Binder:

The cured binder was carefully removed from the pan and added to a 10 mL centrifuge tube. The aluminum pan was rinsed with water and the rinse water was placed into the centrifuge tube. Additional water was added into the centrifuge tube until the final quantity was about 10.0 grams. The centrifuge tubes were capped and then vortexed vigorously for 30 seconds. The solution was filtered with a 0.45 micron syringe filter into a high performance liquid chromatography (HPLC) vial.

Control (non-cured) samples were prepared by adding the binder (0.1-0.3 grams) into a centrifuge tube and diluting it with about 10.0 mL water. The solution was filtered with a 0.45 micron syringe filter into an HPLC vial.

All weights of the control and cured samples were recorded and considered in the data calculations.

HPLC Analysis of Free Citric Acid:

Cured and control samples were analyzed by HPLC using the following conditions.

Column: Bio-Rad 87H

Column Temperature: 60° C.

Mobile Phase: 0.01 N sulfuric acid

Flow Rate: 0.6 mL per minute

Detection: Refractive Index and Ultraviolet at 220 nm

Binder Strength Test:

Comparative binder strength was evaluated by applying incremental force to a fiberglass with applied cured binder. Force was measured using a balance and was determined as the breaking point for the fiberglass.

Results:

The performance of citric acid esterification in the cured binders was evaluated using the percent free citric acid extracted from the cured binder. Table 1 summarizes the results of screening of several different binder compositions (0.1 grams of binder) and shows the percent free citric acid in the cured binder compared to the citric acid used to make the binder (thus, % esterification=100−(the percent residual citric acid (also referred to a “free citric acid”) in the cured binder relative to the original citric acid used to make the binder)) as determined by HPLC under the conditions set forth above. The Binder Control (BC1), containing sodium hypophosphite, performed very well (>98% esterification) and was the benchmark for comparison. Esterification progressed with time and was nearly complete for all samples by about 4 minutes. The binder (BS1) containing citric acid and no trisodium citrate dihydrate (TSC) had poor esterification, with about 33% residual citric acid remaining after 4 minutes. In contrast, the addition of a small amount of TSC significantly improved curing, providing evidence that it promotes crosslinking, esterification, or coupling. Based upon the data in Table 1, sample 3 performed well and included a molar ratio of TSC to citric of 0.036:1 (which corresponds to a molar ratio of sodium hydroxide to citric of 0.108). Binder samples cured for 5 minutes had darker color than those cured for 4 minutes, but had marginally lower free citric acid.

TABLE 1
^{a}Comparison of relative percent residual citric acid

| Cure Time | | | | | | | | |
|---|---|---|---|---|---|---|---|---|
| (min) | BC1 | BS1 | BS2 | BS3 | BS4 | BS5 | BS6 | BS7 |
| 0 | 100.0% | 100.0% | 100.0% | 100.0% | 100.0% | 100.0% | 100.0% | 100.0% |
| 2 | 16.2% | 70.2% | 33.4% | 12.7% | 15.4% | 21.8% | 46.6% | 83.7% |
| 3 | 2.8% | 43.6% | 12.5% | 5.7% | 6.4% | 9.0% | 18.9% | 50.4% |
| 4 | 1.2% | 33.6% | 6.5% | 1.8% | 2.5% | 5.3% | 16.5% | 48.2% |
| 5 | 1.0% | | 3.9% | | 2.0% | | | |

^{a}Samples contained 0.1 grams of binder and were cured at 210° C. for the indicated time

The experiment was repeated with a smaller range of base catalyst or crosslinking promoter added (Table 2). Additionally, a larger quantity of binder was used (0.3 grams vs. 0.1 grams) in order to increase the sensitivity and precision of the HPLC analyses. The results were similar to the experiment summarized in Table 1 except the time required to obtain nearly complete curing. This is believed to be due to the larger quantity of binder used during curing, which required more heat for an equivalent cure. Curing of the binder is sensitive to the curing time, temperature, and quantity of binder to be cured.

TABLE 2
^{a} Comparison of relative percent residual citric acid

| | Binder | TSC/Citric | TSC/Citric | TSC/Citric | TSC/Citric |
|---|---|---|---|---|---|
| Binder Component | Control | Acid (0%) | Acid (3.1%) | Acid (4.1%) | Acid (5.6%) |
| Citric acid (g) | ^{b} | 1.0000 | 0.9800 | 0.9740 | 0.9650 |
| TSC monohydrate (g) | ^{b} | 0.0000 | 0.0300 | 0.0400 | 0.0540 |
| Maltodextrin 0919 (g) | ^{b} | 4.0000 | 4.0000 | 4.0000 | 4.0000 |
| Water (g) | ^{b} | 5.0000 | 5.0000 | 5.0000 | 5.0000 |
| % Free Citric | 1.9% | 52.8% | 8.9% | 6.8% | 8.4% |
| (4 minute cure) | | | | | |
| % Free Citric | 1.6% | 26.9% | 3.3% | 2.2% | 1.7% |
| (5 minute cure) | | | | | |

^{a} Samples contained 0.3 grams of binder and were cured at 210° C. for the indicated time.
^{b} Composition as set forth in Binder Control 1.

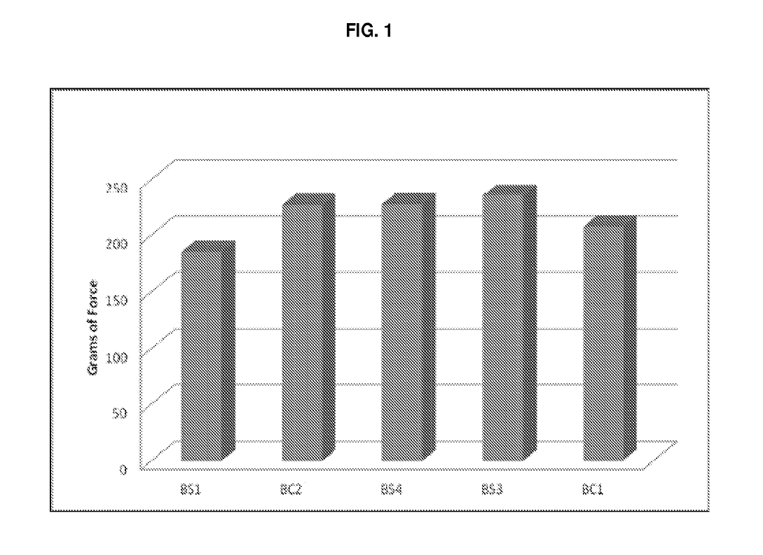

In addition to the free citric acid percentage of the optimized binder containing TSC as the crosslinking promoter being similar to Binder Control 1, the color and morphology of the cured binder was also similar. Referring to FIG. 1, the strength test confirmed that binder containing TSC had more strength than the binder not containing TSC (TSC/Citric Acid=0%), providing additional evidence of crosslinking esterification.

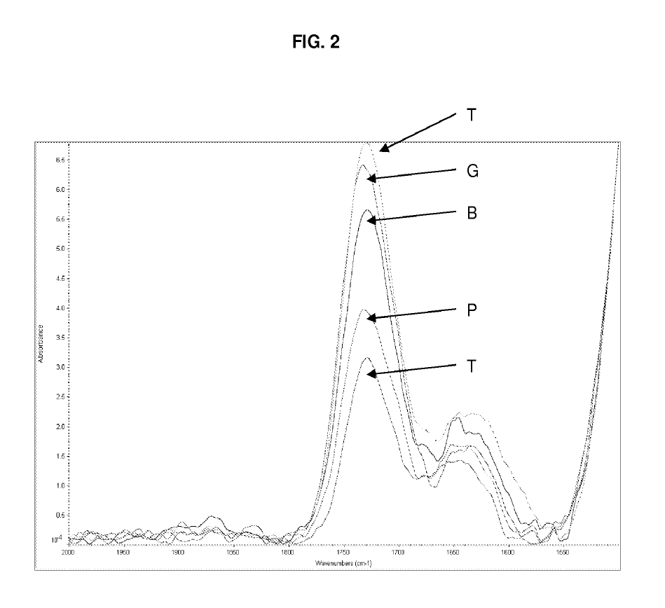

Referring to FIG. 1, fiberglass samples used in the strength test were also examined by FT-IR (FIG. 2). FIG. 2 shows absorbance FT-IR (Fourier transform infrared) spectra of fiberglass samples containing cured binder (˜5% w/w): Binder Control 1 (red, R), Binder Sample 1 (green, G), Binder Control 2 (purple, P), Binder Sample 4 (blue, B), Binder Sample 3 (tan, T). The strong absorbance at 1736 cm-1 is indicative of a citrate ester. Citric acid has a weaker doublet absorbance at 1700 cm-1 and 1747 cm-1 and is not expected to be resolved by the instrument when significant esterification has occurred (>50% esterification).

### Example 2

### Binder Sample Cure Profiles

Binder Control 3 (BC3) was prepared by adding to a 15 mL centrifuge tube 1.00 g citric acid, 0.25 g sodium hypophosphite, 4.00 g maltodextrin, and 5.00 g water.

Binder Sample 8 (BS8) was prepared with 1.00 g citric acid, 0.05 g trisodium citrate dihydrate, 4.00 g maltodextrin, and 5.00 g water.

Tubes containing Binder Control 3 and Binder Sample 8 were vigorously vortexed until all components completely dissolved.

Binder Curing:

Three droplets of the binders (3×0.1 grams) were evenly distributed on an aluminum pan. The pan, containing the binders, was then placed in a muffle furnace at the indicated temperature for the indicated time period. Following the cure, the pan was removed and cooled at ambient.

Moisture Loss Measurement:

Moisture loss was determined gravimetrically as the difference in weight between the starting and cured binder pans. Moisture was corrected for water produced by esterification.

HPLC Analyses for Esterification (Citric Acid):

The cured binders were removed from the aluminum pans into a 15 mL centrifuge tube. 10 mL of water were added to the tubes and they were vigorously vortexed for one minute. The mixture was filtered using a 0.1 micron syringe filter into an HPLC vial for analysis.

HPLC analyses for citric acid was performed using the conditions set forth above.

Acid Determination by Titration:

Cured binder was added to a 50 mL Erlenmeyer flask and titrated with 0.1 M NaOH until the endpoint was reached. Phenolphthalein was used as the indicator. Acid content of the cured binder was determined relative to the non-cured binder using the titration endpoint. Crosslinking was calculated using the free citric acid number and the titration free acid number (Equation 1).

% Crosslinking=(1−% Residual Citric Acid)×((1−% Acid by Titration)/0.66). Equation 1:

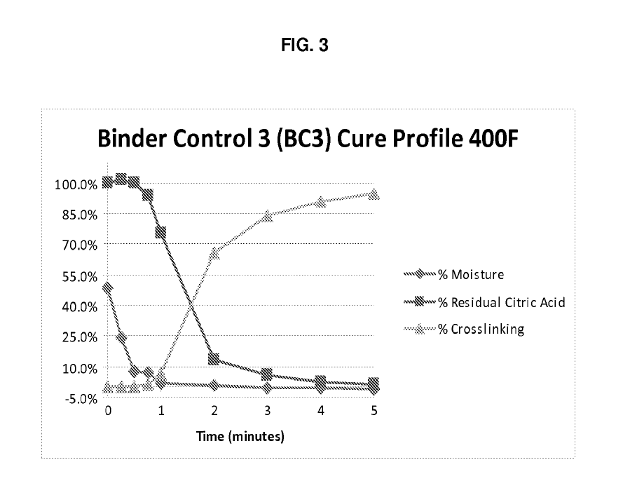

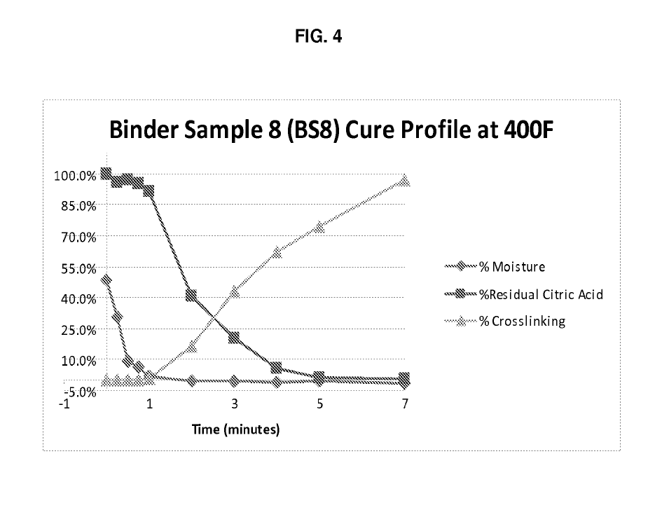

Referring to FIGS. 3-4, profiles of the cure profile for the bonders is shown. For this example, we have defined 100% crosslinking to mean that coupling of on average 2 of the 3 carboxyl groups of citric acid originally present with one or more carbohydrates to form a diester.

### Example 3

### Alkali Metal Comparison

Preparation of the Binder Mixture:

Binder Sample 9 (BS9) was prepared in the following manner. Dry trisodium citrate was combined with dry citric acid in a 95.5:4.5 weight ratio of citric acid to the citrate salts and the mixture was dissolved in water to form a 50% by weight solution first mixture. The first mixture was then added to a 5% by weight solution of 10 DE maltodextrin in a ratio of 80:20, dry weight to dry weight, of maltodextrin to citric acid/metal citrate salts. Binder Sample 10 (BS10) was prepared in the same manner as Binder Sample 9. Namely, dry tripotassium citrate was combined with dry citric acid in a 95.5:4.5 by weight ratio of citric acid to the citrate salts and the mixture was dissolved in water to form a 50% by weight solution first mixture. The first mixture was then added to a 5% by weight solution of 10 DE maltodextrin in a ratio of 80:20, dry weight to dry weight, of maltodextrin to citric acid/metal citrate salts. A Binder Control 4 (BC4) was prepared as follows: a 50% by weight solution of citric acid was combined with a 5% by weight solution of 10 DE maltodextrin in a ratio of 80:20, dry weight to dry weight, of maltodextrin to citric acid. These test binder solutions were then used to prepare binder-containing glass filter disks, utilizing the following preparation methodology.

Preparation of the Glass Microfiber Filter Disks:

A 70 mm paper filter (Whatman 40 Ashless) was placed in a 70 mm Buchner vacuum filter funnel fitted with a vacuum filter flask. A single 47 mm glass microfiber filter (Whatman 934-AH) was placed on top of the paper filter and a 5 ml binder solution was added to the filters and allowed to soak for 30 seconds. Vacuum was then applied for 15 seconds and removed, followed by careful separation of the glass microfiber filter from the paper filter. The glass microfiber filter containing the residual binder was then placed on a metal plate. Two additional test filters were prepared and added to the metal plate. The metal plate containing the 3 binder-containing glass microfiber filters was then placed in a ash oven at a temperature of 250° C. for 5 minutes. The cured binder-containing glass microfiber filters were allowed to cool and equilibrate to room temperature and humidity before testing (typically 1-2 hours).

Stiffness Test:

A Model CVO 120 Bolin Rheometer was modified to allow for the inclusion of a Mettler balance below the traveling head of the rheometer. The vertical up and down movement of the traveling head was used to apply an increasing force to a suspended test glass filter. The glass filter was suspended on a open metal cup where the rim was 2 mm in diameter less than the 70 mm glass filter disk. The rheometer bob holder was fitted with a metal spindle to which the end contacting the surface of the glass filter disk was 5 mm in diameter. The metal cup containing the glass filter test disk was placed on top of the Mettler balance and centered such that the 5 mm metal disk of the rheometer was centered on the glass microfiber test disk. The Mettler balance was zeroed. The traveling head of the rheometer was adjusted to its lowest traveling rate of 7 mm/minute. As the 5 mm metal disk contacted the surface of the glass microfiber disk, the force in grams, as measured by the Mettler balance, increased. At the failure point of the glass microfiber disk, a wrinkle developed and there was an immediate drop in the grams of force recorded by the Mettler balance. The highest measured grams of force was recorded for each test disk and averaged for that particular test condition.

Results:

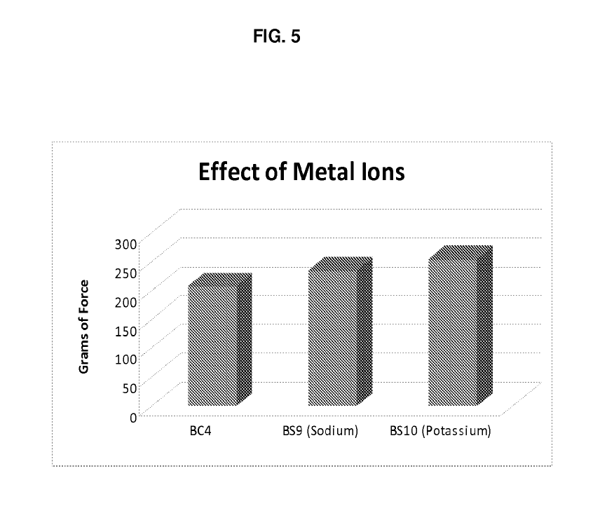

Referring to FIG. 5, in this example it was found that the glass microfiber disks made with compositions to which the sodium and potassium citrate salts were added were significantly higher in stiffness value than the control without the alkali metal salt of citric acid. Additionally, it was found that the glass microfiber disks made from compositions to which potassium citrate salt was added were significantly higher in stiffness value than the glass microfiber disks made from compositions to which sodium citrate salt was added.

As shown in the above examples, an inexpensive base, such as alkali metal salt of citric acid (e.g., trisodium citrate) or an alkali metal hydroxide (e.g. sodium or potassium hydroxide), can effectively modify citric acid to promote esterification of citric acid to maltodextrin.

Although the invention has been described with respect to specific embodiments and examples, it will be readily appreciated by those skilled in the art that modifications and adaptations of the invention are possible without deviation from the spirit and scope of the invention. Accordingly, the scope of the present invention is limited only by the following claims.

1-10. (canceled)

11. The composition of claim 25 wherein the alkali metal salt of citric acid comprises trisodium citrate, tripotassium citrate, or a mixture thereof.

12-24. (canceled)

25. A composition for use in making a cured binder, the composition comprising:
an aqueous solution comprising a carbohydrate, and the reaction products of citric acid, and (i) an alkali metal salt of citric acid, (ii) an alkali metal hydroxide, or (iii) mixtures thereof,
wherein about 0.03% to 20% of the carboxylic acid groups of the citric acid are neutralized in the aqueous solution prior to curing,
the ratio of carbohydrate to citric acid is about 1:1 to 9:1 by weight, and
upon curing to form a cured binder, the amount of citric acid in the cured binder is about 20% or less of the amount of citric acid in the aqueous solution prior to curing.

26. The composition of claim 25 wherein about 1.5% to 10% of the carboxylic acid groups of the citric acid are neutralized in the aqueous solution prior to curing.

27. The composition of claim 25 wherein about 3% to 7% of the carboxylic acid groups of the citric are neutralized in the aqueous solution prior to curing.

28. The composition of claim 25 wherein the aqueous solution comprises the reaction product trisodium citrate and citric acid.

29. The composition of claim 25 wherein aqueous solution comprises the reaction product of sodium hydroxide and citric acid.

30. A method of making a cured binder, the method comprising:
providing a first aqueous solution comprising the reaction products of citric acid and (i) an alkali metal salt of citric acid, (ii) an alkali metal hydroxide, or (iii) mixtures thereof, wherein about 0.03% to 20% of the carboxylic acid groups of the citric acid are neutralized in the first aqueous solution,
combining the first aqueous solution with a carbohydrate to form a second aqueous solution, wherein the ratio of carbohydrate to citric acid in the second aqueous solution is about 1:1 to 9:1 by weight;
curing the second aqueous solution at an elevated temperature for a sufficient time to form a cured binder, wherein the amount of citric acid in the cured binder is about 20% or less of the amount of citric acid in the second aqueous solution.

31. The method of claim 30 wherein about 1.5% to 10% of the carboxylic acid groups of the citric acid are neutralized in the first aqueous solution.

32. The method of claim 30 wherein about 3% to 7% of the carboxylic acid groups of the citric acid are neutralized in the first aqueous solution.

33. The method of claim 30 wherein the first aqueous solution comprises the reaction products of sodium hydroxide or potassium hydroxide and citric acid.

34. The method of claim 30 wherein the first aqueous solution comprises the reaction products of trisodium citrate and the citric acid.

35. The method of claim 30 wherein the first aqueous solution comprises the reaction products of citric acid and both an alkali metal hydroxide and an alkali metal salt of citric acid.

36. A method of making a cured binder, the method comprising:
combining citric acid, (i) an alkali metal acid salt of citric acid, (ii) a alkali metal hydroxide, or (iii) a mixture thereof, a carbohydrate, and water to form a first aqueous solution,
wherein about 0.03% to 20% of the carboxylic acid groups of the citric acid are neutralized in the first aqueous solution, and the ratio of carbohydrate to citric acid is about 1:1 to 9:1 by weight;
curing the first aqueous solution at an elevated temperature for a sufficient time to form a cured binder, wherein the amount of citric acid in the cured binder is about 20% or less of the amount of citric acid combined to form the first aqueous solution.

37. The method of claim 36 wherein about 1.5% to 10% of the carboxylic acid groups of the citric acid are neutralized in the first aqueous solution.

38. The method of claim 36 wherein about 3% to 7% of the carboxylic acid groups of the citric acid are neutralized in the first aqueous solution.

39. The method of claim 36 wherein the first aqueous solution comprises the reaction products of citric acid and sodium hydroxide or potassium hydroxide.

40. The method of claim 36 wherein the first aqueous solution comprises the reaction products of citric acid and trisodium citrate.

41. The method of claim 36 wherein the first aqueous solution comprises the reaction products of citric acid and both an alkali metal hydroxide and an alkali metal salt of citric acid.

42. A method of promoting esterification of citric acid with a carbohydrate, the method comprising:
combining citric acid, (i) an alkali metal acid salt of citric acid, (ii) a alkali metal hydroxide, or (iii) a mixture thereof, a carbohydrate, and water to form a first aqueous solution,
wherein about 0.03% to 20% of the carboxylic acid groups of the citric acid are neutralized in the first aqueous solution, and the ratio of carbohydrate to citric acid combined in the first aqueous solution is about 1:1 to 9:1 by weight;
heating the first aqueous solution at an elevated temperature for a sufficient time to esterify at least 80% of the citric acid combined in the first aqueous solution.

43. The composition of claim 30 wherein the alkali metal salt of citric acid comprises trisodium citrate, tripotassium citrate, or a mixture thereof.
